(19) United States
(12) Patent Application Publication
(10) Pub. No.: US 2010/0214173 A1
(43) Pub. Date: Aug. 26, 2010

(54) CHIP ANTENNA

(75) Inventor: Yasumasa Harihara, Tokyo (JP)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: TDK CORPORATION, Tokyo (JP)

(21) Appl. No.: 12/280,233

(22) PCT Filed: Feb. 27, 2007
(86) PCT No.: PCT/JP2007/053569

§ 371 Date: Aug. 21, 2008

(30) Foreign Application Priority Data
Feb. 28, 2006 (JP) 2006-052917

(51) Int. Cl. H01Q 1/38

(52) U.S. Cl. 343/700 MS

(57) ABSTRACT

The present invention provides a chip antenna of which chip size can be smaller and a mounting area can be also reduced by increasing an effective specific inductive capacity. A chip antenna 10 according to the present invention includes a rectangular base substance 11 made of dielectric, a feeding electrode 12 formed on one main surface 11a of the base substance 11, a strip-line-shaped emission electrode 13 having an approximate length λ/4 formed on the main surface 11a of the base substance 11 to face the feeding electrode 12 via a gap g, fixing electrodes 14a and 14b formed on the other main surface 11b of the base substance 11, and through-holes 15a and 15b piercing through the inside of the base substance 11. The feeding electrode 12 and the emission electrode 13 are not connected to the fixing electrodes 14a and 14b via a side surface of the base substance 11. Electrodes on upper and lower surfaces are electrically connected to each other via through-holes piercing through the base substance from the one main surface 11a to the other main surface 11b of the base substance 11.

### TECHNICAL FIELD

The present invention relates to a chip antenna, and, particularly relates to an electrode structure of a chip antenna, which is compact and has an excellent high-frequency characteristic.

### BACKGROUND OF THE INVENTION

For example, Patent document 1 describes a conventional chip antenna. As shown in FIG. 10, the conventional chip antenna includes a rectangular base substance (dielectric block) 1 made of dielectric, and has a strip-line-shaped emission electrode 2 having an approximate length λ/4 formed on the dielectric block. One end of this emission electrode 2 constitutes an open end extending to near one side of the dielectric block 1. The other end of the emission electrode 2 is connected to a ground electrode 3 formed on the rear surface of the base substance 1 via an end surface 1a opposite to the one side. An excitation electrode (feeding electrode) 4 is formed near this one side, via the open end of the emission electrode 2 and a gap g. The excitation electrode 4 is extended from an end surface 1b opposite to the end surface 1a, to the rear surface of the base substance 1. A clearance is provided between the excitation electrode 4 and the ground electrode 3, on the rear surface of the base substance 1, thereby electrically insulating between the both. The excitation electrode 4 and the emission electrode 2 are electromagnetically coupled by capacitance formed in the gap g.

An electric equivalent circuit of the chip antenna having the above configuration has a series connection of a capacitance C formed by the gap g, and an inductance L and emission resistor R of the emission rode 2, via the ground. A high-frequency signal f supplied to the excitation electrode 4 is electromagnetically coupled with the emission electrode 2 by the capacitance C formed by the gap g, and is emitted as a radio wave. Therefore, excitation can be performed in no-contact, and a matching can be performed even when the chip antenna is made compact.

See Patent document 1 (Japanese Patent Application Laid-open No. H9-98015) and Patent document 2 (Japanese Patent Application Laid-open No. 2003-37421)

### SUMMARY OF THE INVENTION

However, the above conventional chip antenna has the emission electrode 2 and the excitation electrode 4 formed on only the surface of the base substance 1. Therefore, effective specific inductive capacity of the base substance is not sufficient, and the chip cannot be downsized. Further, because the emission electrode 2 and the excitation electrode 4 are also present on side surfaces (end surfaces) of the base substance 1, solder needs to be formed on the side surfaces as well, at the mounting time. As a result, the mounting area of the chip antenna disadvantageously becomes large.

Therefore, an object of the present invention is to provide a chip antenna having a smaller chip size and having a smaller mounting area, by increasing the effective specific inductive capacity.

The above and other objects of the present invention can be accomplished by a chip antenna comprising: a base substance made of dielectric; a emission electrode formed on the one main surface of the base substance; at least two through-hole electrodes formed inside of the base substance to pierce through the base substance from the one main surface to the other main surface; a fixing electrode formed on the other main surface of the base substance and connected to the emission electrode via the through-holes at the very least;

Particularly, it is preferable that the chip antenna includes: a base substance made of dielectric provided with first and second through-holes piercing through the base substance from one main surface to the other main surface; a feeding electrode and a emission electrode formed on the one main surface of the base substance; first and second fixing electrodes formed on the other main surface of the base substance; a first through-hole electrode formed within the first through-hole, and connecting between the feeding electrode and the first fixing electrode; and a second through-hole electrode formed within the second through-hole, and connecting between the emission electrode and the second fixing electrode, where a shape of the base substance including formation positions of the first and second through-holes is symmetrical.

Preferably, in the chip antenna according to the present invention, the emission electrode is formed to face the feeding electrode via a gap.

Preferably, in the present invention, the first fixing electrode is connected to a feeding line on a circuit substrate, the second fixing electrode is connected to a ground line on the circuit substrate, and the first and second fixing electrodes are connected by solder onto the circuit substrate.

In the present invention, three or more through-hole electrodes can be formed. According to this, various kinds of chip antennas can be manufactured, by employing necessary through-holes depending on a kind of antenna, and by forming an electrode pattern on the surface of the base substance. That is, there is no need to prepare an exclusive mold for each chip antenna, and therefore, manufacturing cost can be reduced. Further, a characteristic-adjustment range increases, and the weight of the chip antenna can be reduced.

As one example, it is preferable that the chip antenna further includes: a third through-hole piercing through the base substance from the one main surface to the other main surface; a third fixing electrode formed on the other main surface of the base substance; and a third through-hole electrode formed within the third through-hole, and connecting between the emission electrode and the third fixing electrode.

As another example, it is preferable that the chip antenna further includes third and fourth through-holes piercing through the base substance from the one main surface to the other main surface, where a shape of the base substance including formation positions of the first to fourth through-holes is symmetrical.

In the present invention, the emission electrode can be formed in a meander shape. According to this, the emission electrode can be made longer. Therefore, when the emission electrode has a constant length, the base substance can be made smaller, and the chip can be downsized. Particularly, when no gap is formed and when the chip antenna is configured by only an inductance component of the emission electrode, the impedance can be adjusted easily even when a capacitance between the emission electrode and the ground is relatively large.

According to the present invention, wavelength shortening effect of the base substance can be improved, and the chip can be downsized, by forming a through-hole inside the base substance. Because the chip antenna can be mounted using only a bottom-surface terminal, by employing a through-hole and by avoiding a side-surface electrode, a mounting area of the antenna can be reduced.

When the base substance including formation positions of through-holes is made symmetrical, an electrode can be formed without discriminating a direction of the base substance.

### BRIEF DESCRIPTION OF THE DRAWINGS

FIG. 1 is a schematic perspective view showing a configuration of a chip antenna according a preferred embodiment of the present invention;

FIG. 2 is a schematic cross-sectional view cut along a line A-A in FIG. 1;

FIG. 3 is an electrically equivalent circuit diagram of the chip antenna 10;

FIG. 4 is a schematic perspective view showing a configuration of a chip antenna 20 according to a second embodiment of the present invention;

FIGS. 5A and 5B are schematic perspective views showing configurations of chip antennas 30 and 40 according to the third embodiment of the present invention;

FIG. 6 is a schematic perspective view showing a configuration of a chip antenna 50 according to a fourth embodiment of the present invention;

FIG. 7 is a schematic perspective view showing a configuration of a chip antenna 60 according to a fifth embodiment of the present invention;

FIG. 8 is an electric equivalent circuit diagram of the chip antenna 60;

FIG. 9 is a schematic perspective view showing a configuration of a modified example of the chip antenna 60; and

FIG. 10 is a schematic perspective view showing a configuration of a conventional chip antenna.

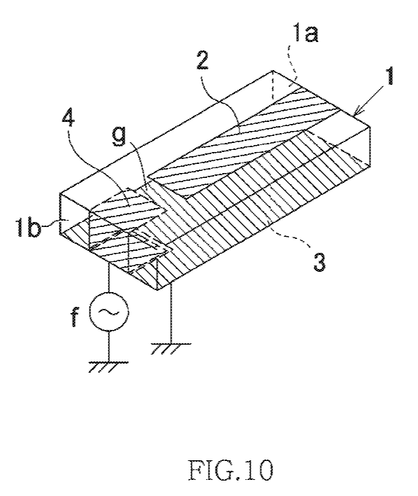

### DETAILED DESCRIPTION OF THE EMBODIMENTS

Preferred embodiments of the present invention will now be explained in detail with reference to the drawings.

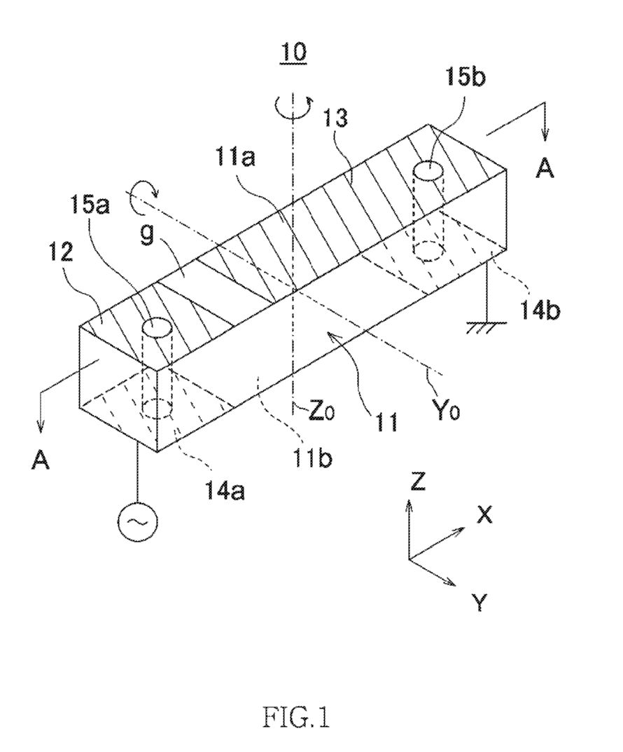

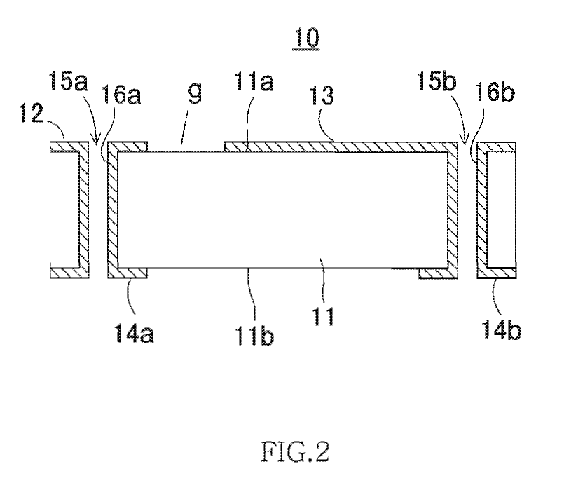

FIG. 1 is a schematic perspective view showing a configuration of a chip antenna according a preferred embodiment of the present invention. FIG. 2 is a schematic cross-sectional view cut along a line A-A in FIG. 1.

As shown in FIG. 1 and FIG. 2, a chip antenna 10 includes a rectangular base substance 11 made of dielectric, a feeding electrode 12 formed on one main surface 11a of the base substance 11, a strip-line-shaped emission electrode 13 having an approximate length λ/4 formed on the main surface 11a of the base substance 11 to face the feeding electrode 12 via the gap g, fixing electrodes 14 (14a, 14b) formed on the other main surface 11b of the base substance 11, and through-holes 15 (15a, 15b) piercing through the inside of the base substance 11.

The one through-hole 15a pierces through the base substance 11 from the one main surface 11a to the other main surface 11b, and has the feeding electrode 12 and the fixing electrode 14a electrically connected to each other by a through-hole electrode 16a formed on an inner-wall surface of the through-hole 15a. That is, the feeding electrode 12 is not connected to the fixing electrode 14a via a side surface of the base substance 11. At the time of mounting the chip antenna onto a circuit substrate, the fixing electrode 14a is connected to the feeding line by solder, and a high-frequency signal is supplied from the fixing electrode 14a to the feeding electrode 12 via the through-hole electrode 16a.

The other through-hole 15b pierces the base substance 11 from the one main surface 11a to the other main surface 11b, and has the emission electrode 13 and the fixing electrode 14b electrically connected to each other by a through-hole electrode 16b formed on an inner-wall surface of the through-hole 15b. That is, the emission electrode 13 is not connected to the fixing electrode 14b via the side surface of the base substance 11. At the time of mounting the chip antenna onto a circuit substrate, the fixing electrode 14a is connected to the ground line by solder.

The through-holes 15a and 15b fulfill the role of securing electric conduction between the upper and the lower surfaces of the base substance, and also fulfill the role of improving a wavelength shortening effect of the base substance 11. By improving the wavelength shortening effect of the base substance 11 based on the formation of the through-holes, effective specific inductive capacity of the base substance 11 can be improved. That is, when the effective specific inductive capacity is made constant, the size of the base substance 11 can be made smaller, and the chip can be downsized.

In the present embodiment, it is preferable that the shape of the base substance 11 including the formation positions of the through-holes 15a and 15b is symmetrical, for example, bilaterally symmetrical. More specifically, as shown in FIG. 1, when a layout direction of the through-holes is an X-direction, when a direction orthogonal with the X-direction is a Y-direction, and also when a direction orthogonal with the X-direction and the Y-direction is a Z-direction, the base substance is preferably rotationally symmetrical using at least one of a center line Y₀ in the Y-direction and a center line Z₀ in the Z-direct on as a rotation axis. With this arrangement, the feeding electrode 12 and the emission electrode 13 can be formed without paying any particular attention to a direction of the base substance 11. That is, when the base substance 11 is rotationally symmetrical in the Y-direction or in the Z-direction, the same shape can be obtained, even if the positions of the through-holes are switched by rotating the substance 11 by 180° in the Y-direction or in the Z-direction.

Particularly, it is preferable that the chip antenna 10 is rotationally symmetrical around the rotation axis of the center line Y₀ and is also rotationally symmetrical around the rotation axis of the center line Z₀, as shown in FIG. 1. With this arrangement, the chip antenna has the same shape even when the positions of the through-holes are switched with each other by rotating the base substance 11 by 180° in the Y-direction, and also the chip antenna has the same shape even when the positions of the through-holes are switched with each other by rotating the base substance 11 by 180° in the Z-direction. Because the chip antenna 10 shown in FIG. 1 is rotationally symmetrical even when the center line in the X-direction is set as a rotation axis, the chip antenna 10 has the same shape even when the base substance 11 is rotated by 180° in either direction.

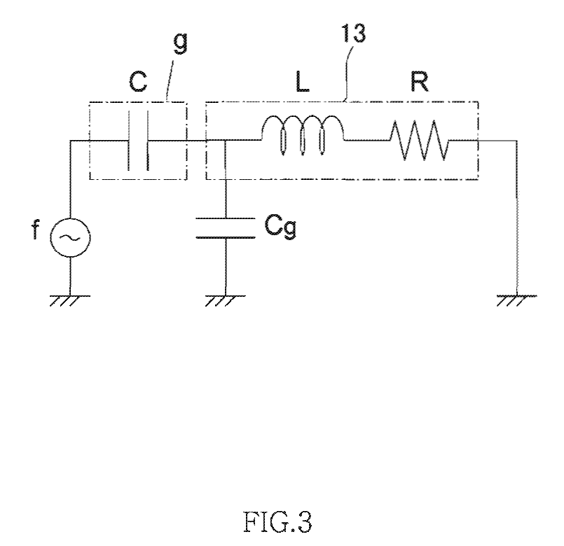

FIG. 3 is an electrically equivalent circuit diagram of the chip antenna 10.

As shown in FIG. 3, the electrically equivalent circuit of the chip antenna 10 has a series connection of the capacitance C formed by the gap g, and the inductance L and the discharge resistor R of the emission electrode 13, between the feeding line and the ground. At the same time, a capacitance Cg is inserted into between the emission electrode 13 and the ground. The high-frequency signal f supplied to the feeding electrode 12 is electromagnetically coupled with the emission electrode 13 by the capacitance C formed by the gap g, and is emitted as a radio wave.

As explained above, according to the present embodiment, plural through-holes 15 are formed in the base substance 11. Further, the feeding electrode 12 and the emission electrode 13 formed on the surface of the base substance 11 are electrically connected with the fixing electrode 14 formed on the rear surface of the base substance 11, with the through-hole electrode 16. Therefore, the effective specific inductive capacity of the base substance can be improved, thereby downsizing the chip. Because the electrodes can be removed from the side surfaces, and because only the bottom-surface terminal is used at the mounting time, solder does not need to be formed on the side surfaces at the mounting time. As a result, the mounting area can be reduced.

Furthermore, when the base substance 11 is made rotationally symmetrical by making at least one of the center line Y₀ and the center line Z₀ as a rotation axis, the chip antenna has the same shape even when the base substance 11 is rotated by 180°. Therefore, the electrode can be formed without discriminating the direction of the base substance 1. As a result, work efficiency is improved, and manufacturing cost can be reduced.

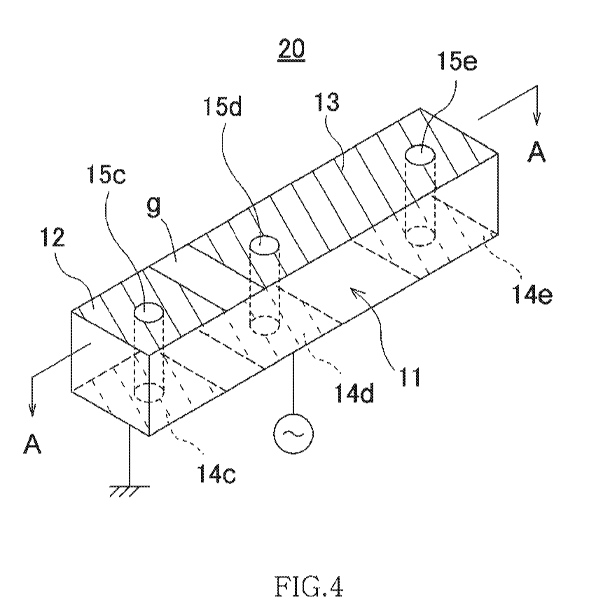

FIG. 4 is a schematic perspective view showing a configuration of a chip antenna 20 according to a second embodiment of the present invention.

As shown in FIG. 4, the chip antenna 20 is configured as an inverse F antenna. The chip antenna 20 is characterized by including three through-holes 15 (15c, 15d, 15e), and also including three fixing electrodes 14 (14c, 14d, 14e) corresponding to these through-holes. The through-hole 15c is used to connect between the feeding electrode 12 and the fixing electrode 14c. The through-hole 15d is used to connect between the emission electrode 13 and the fixing electrode 14d. The through-hole 15e is used to connect between the emission electrode 13 and the fixing electrode 14e. At the time of mounting on the circuit substrate, the fixing electrode 14c is connected to the ground line, and the fixing electrode 14d is connected to the feeding line. The fixing electrode 14e is connected to the open line. Other configurations are substantially the same as those in the first embodiment, and therefore detailed explanations thereof will be omitted here.

According to the present embodiment, the chip antenna can be configured as the inverse F antenna. Therefore, this inverse F antenna can obtain a similar effect to that of the first embodiment. That is, the wavelength shortening effect of the base substance 11 can be improved, thereby downsizing the chip. Because the electrodes can be removed from the side surfaces, and because only the bottom-surface terminal is used at the mounting time, solder does not need to be formed on the side surfaces at the mounting time. As a result, the mounting area can be reduced.

In the present embodiment, when the through-hole 15d is laid out at a center part of the base substance 11, the shape of the base substance 11 including formation positions of the through-holes 15c, 15d, and 15e can be also made rotationally symmetrical, thereby improving work efficiency. However, when the through-hole 15d cannot be easily laid out at the center part of the base substance due to a required antenna characteristic, four or five or more) through-holes can be provided, on the base substance 11, as in a third embodiment described later.

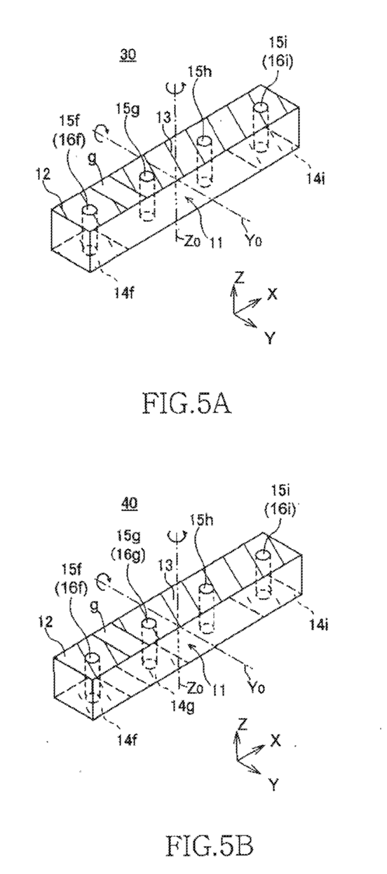

FIGS. 5A and 5B are schematic perspective views showing configurations of chip antennas 30 and 40 according to the third embodiment of the present invention.

As shown in FIGS. 5A and 5B, the chip antennas 30 and 40 are characterized by having more through-holes 15 of the base substance 11, respectively. While external shapes of the base substances 11 are the same, shapes of electrodes are different.

The chip antenna 30 shown in FIG. 5A has fixing electrodes 14f and 14i provided in through-holes 15f and 15i at both ends, out of four through-holes 15f, 15g, 15h, and 15i. Further, electrodes on upper and lower surfaces are electrically connected to each other via through-holes 16f and 16i. However, corresponding fixing electrodes are not provided in the intermediate through-holes 15g and 15h, and only the through-holes are formed.

On the other hand, the chip antenna 40 shown in FIG. 5B has fixing electrodes provided in three through-holes 15f, 15g, and 15i, out of the four through-holes 15f, 15g, 15h, and 15i. Further, electrodes on upper and lower surfaces are electrically connected to each other via the rough-holes 16f, 16g, and 16i. However, corresponding fixing electrodes are not provided in the remaining through-hole 15c, and only the through-hole is formed.

The base substances 11 of these chip antennas 30 and 40 are common. That is, the common base substance 11 formed with plural through-holes 15 is prepared in advance. Necessary through-holes are selectively used corresponding to kinds of antennas. An electrode pattern is formed on the main surface of the base substance 11. With the above arrangement, various types of chip antennas can be manufactured. In this case, an exclusive mold does not need to be prepared for each chip antenna. Therefore, manufacturing cost can be reduced. Further, an antenna-characteristic adjustment range increases, and weight of the chip antenna can be reduced. Like in the first embodiment, it is also preferable in the present embodiment that a shape of the base substance 11 including the formation positions of the through-holes is symmetrical, for example, bilaterally symmetrical. More specifically, in the present embodiment, the base substance 11 is also preferably rotationally symmetrical using at least one of the center line Y₀ and the center line Z₀ as a rotation axis.

Therefore, in the chip antenna 30 shown in FIG. 4, when the through-hole 15d cannot be easily laid out at the center part of the base substance 11 due to a required antenna characteristic, the use of four through-holes as shown in FIG. 5B makes it possible to have a symmetrical shape of the base substance 11 while obtaining a required characteristic.

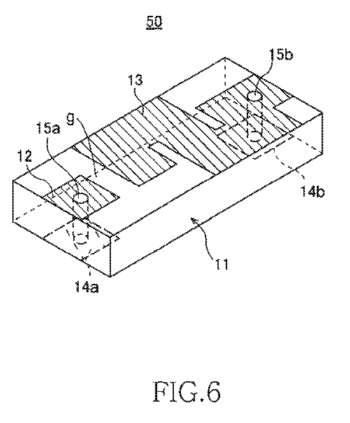

FIG. 6 is a schematic perspective view showing a configuration of a chip antenna 50 according to a fourth embodiment of the present invention.

As shown in FIG. 6, the chip antenna 50 has a substantially meander-shaped emission electrode 13 formed on the one main surface 11a of the base substance 11. The “substantially meander-shaped” also includes a U-shaped curve of the electrode pattern. Other configurations are substantially the same as those in the first embodiment, and therefore detailed explanations thereof will be omitted here. According to the present embodiment, the emission electrode 13 can be made longer. Therefore, when the length of the emission electrode 13 is made constant, the size of the base substance 11 can be made smaller, and the chip can be downsized.

According to the respective embodiments described above, the capacitance Cg generated between the antenna and the ground on the base substance becomes larger depending on a layout of the chip antenna. In this case, impedance adjustment in the capacitance based on the gap g is very difficult. However, the impedance adjustment becomes possible in the following chip antenna.

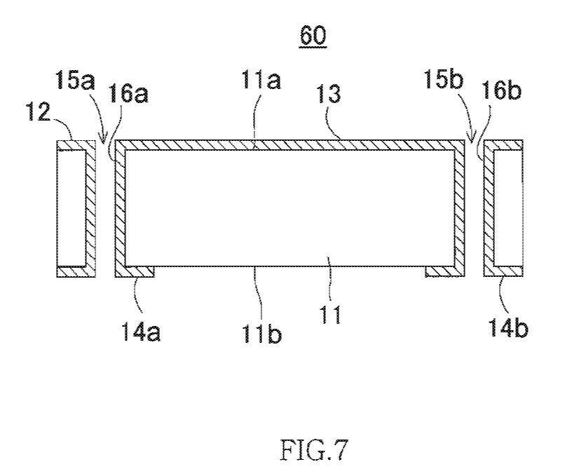

FIG. 7 is a schematic perspective view showing a configuration of a chip antenna 60 according to a fifth embodiment of the present invention.

As shown in 7, this chip antenna 60 includes the rectangular base substance 11 made of dielectric, the strip-line-shaped emission electrode 13 having an approximate length λ/4 formed on the total of the one main surface 11a of the base substance 11, the fixing electrodes 14 (14a, 14b) formed on the other main surface 11b of the base substance 11, and the through-holes 15 (15a, 15b) piercing through the inside of the base substance 11. That is, the chip antenna 60 is characterized by not having the gap g, and having mainly an inductance component of the emission electrode 13 to configure the antenna.

Therefore, the emission electrode 13 is electrically connected to the fixing electrode 14a by the through-hole electrode 16a. At the time of mounting on the circuit substrate, the fixing electrode 14a is connected by solder to the feeding line, thereby directly supplying a high-frequency signal from the fixing electrode 14a to the emission electrode 13 via the through-hole 16a. The emission electrode 13 is electrically connected to the fixing electrode 14b by the through-hole electrode 16b. At the time of loading on the circuit substrate, the fixing electrode 14a is connected to the ground line by solder.

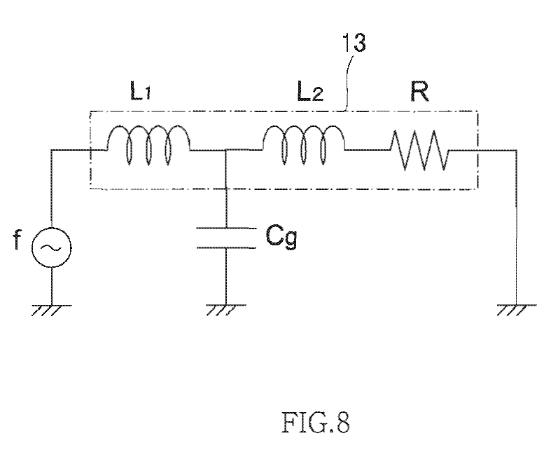

FIG. 8 is an electric equivalent circuit diagram of the chip antenna 60.

As shown in FIG. 8, the electrically equivalent circuit of the chip antenna 60 has a series connection of inductances L1, L2 and the emission register R of the emission electrode 13, between the feeding line and the ground. At the same time, the capacitance Cg is inserted into between the emission electrode 13 and the ground. The high-frequency signal f supplied to the feeding electrode 12 is emitted as a radio wave, by resonance of the inductances L1, L2 and the discharge resistor R.

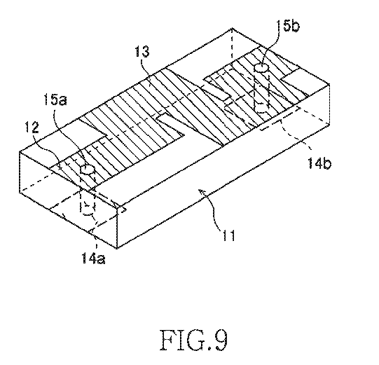

As explained above, according to the present embodiment, even when the capacitance generated between the antenna and the ground of the substrate is large, impedance can be easily adjusted by adjusting the shape of the emission electrode 13. To sufficiently increase the inductance component of the emission electrode 13, the emission electrode 13 should have a meander shaped, as shown in FIG. 9. With this arrangement, the inductance component of the emission electrode 13 becomes larger, and the antenna impedance can be adjusted easily.

The present invention is in no way limited to the aforementioned embodiments, but rather various modifications are possible within the scope of the invention as recited in the claims, and naturally these modifications are included within scope of the invention.

For example, while it is explained in the first embodiment that the emission electrode 13 is connected to the ground line via the through-hole electrode 16b and the fixing electrode 15b, the fixing electrode can be set as an open end.

What is claimed is:

1. A chip antenna comprising:
a base substance made of dielectric material provided with first and second through-holes piercing through the base substance from one main surface to the other main surface;
a feeding electrode and an emission electrode formed on the one main surface of the base substance;
first and second fixing electrodes formed on the other main surface of the base substance;
a first through-hole electrode formed within the first through-hole, and connecting between the feeding electrode and the first fixing electrode; and
a second through-hole electrode formed within the second through-hole, and connecting between the emission electrode and the second fixing electrode, wherein
a shape of the base substance including formation positions of the first and second through-holes is symmetrical.

2. The chip antenna as claimed in claim 1, wherein the emission electrode is formed to face the feeding electrode via a gap.

3. The chip antenna as claimed in claim 1, wherein the first fixing electrode is to be connected to a feeding line on a circuit substrate, and the second fixing electrode is to be connected to a ground line on the circuit substrate.

4. The chip antenna as claimed in claim 1, wherein the first and second fixing electrodes are to be connected by solder onto the circuit substrate.

5. The chip antenna as claimed in claim 1, further comprising:
a third through-hole piercing through the base substance from the one main surface to the other main surface;
a third fixing electrode formed on the other main surface of the base substance; and
a third through-hole electrode formed within the third through-hole, and connecting between the emission electrode and the third fixing electrode.

6. The chip antenna as claimed in claim 1, further comprising third and fourth through-holes piercing through the base substance from the one main surface to the other main surface, wherein
a shape of the base substance including formation positions of the first to fourth through-holes is symmetrical.

7. The chip antenna as claimed in claim 1, wherein the emission electrode is formed in a substantially meander shape.

8. The chip antenna as claimed in claim 1, wherein when a layout direction of the first and second through-holes is an X-direction, when a direction orthogonal with the X-direction is a Y-direction, and also when a direction orthogonal with the X-direction and the Y-direction is a Z-direction, the base substance is rotationally symmetrical using at least one of a center line in the Y-direction and a center line in the Z-direction as a rotation axis.

9. The chip antenna as claimed in claim 8, wherein the base substance is rotationally symmetrical using the center line in the Y-direction as a rotation axis, and is also rotationally symmetrical using the center line in the Z-direction as a rotation axis.
